(19) United States
(12) Patent Application Publication
(10) Pub. No.: US 2026/0270279 A1
(43) Pub. Date: Sep. 10, 2026

(54) ANOMALY DETECTION AND REMEDIATION IN NETWORK ENVIRONMENTS USING DYNAMIC ENGINE

(71) Applicant: BANK OF AMERICA CORPORATION, Charlotte, NC (US)

(72) Inventors: Srinath Chakravarty, Plano, TX (US); Arvin Bewtra, Monroe Township, NJ (US); Swarnali Das, Singagore (SG); Manmohan Datla-Viswasai, Frisco, TX (US); Carolina Lion He, Brooklyn, NY (US); Vismay Mandloi, Kendall Park, NJ (US); Petar Puskarich, Murphy, TX (US); Madhukiran Bangalore Ramachandra, San Ramo, CA (US); Elina Shkodnik, Staten Island, NY (US); Rajaram M. Suram, Plainsboro, NY (US)

(73) Assignee: BANK OF AMERICA CORPORATION, Charlotte, NC (US)

(21) Appl. No.: 19/069,810

(22) Filed: Mar. 4, 2025

(51) Int. Cl. H04L 9/40; H04L 41/22

(52) U.S. Cl. CPC H04L 63/1425; H04L 41/22; H04L 63/1416

(57) ABSTRACT

Systems, computer program products, and methods are described herein for anomaly detection and remediation in network environments using dynamic engine. The present disclosure is configured to receive and extract network data from one or more distributed networks, as well as identifying one or more distributed network data domains based on the network data. In addition, the present disclosure is configured to generate a network attribute set based on at least the one or more distributed network data domains, wherein the network attribute set comprises network attributes, and to determine, using a dynamic engine, one or more thresholds associated with the one or more network attributes. Also, the dynamic engine identifies one or more network anomalies based on at least the one or more thresholds associated with the one or more network attributes and transmits an anomaly alert notification, wherein the anomaly alert comprises the one or more network anomalies.

### TECHNOLOGICAL FIELD

Example embodiments of the present disclosure relate to anomaly detection and remediation in network environments using dynamic engine.

Effective and secure management of network environments requires anomaly detection and efficient anomaly remediation. As distributed network adoption has increased, network environment management tools have implemented balkanized network environment data management methods. Such balkanized network environment data management methods allow for custom segmentation, which can result in specific data fragmentation for certain applications. Furthermore, this approach has resulted in data segmentation in both public and private network environments. However, this splintering of network data makes network anomaly detection and remediation challenging. For example, understanding network anomaly threats at a global and localized level within network environments is paramount to effective anomaly remediation, network security, and operational excellence. Network environment data that has been siloed via segmentation results in disparate anomaly detection in network environments, which can increase threat levels. In addition, network performance can suffer due to unmitigated network anomalies and poor network environment data management. As network environments further increase in complexity, it is essential to develop methods for effective anomaly detection and mitigation to improve security, network performance, and network environment data management and analytics.

Applicant has identified a number of deficiencies and problems associated with anomaly detection and remediation in network environments using dynamic engine. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for anomaly detection and remediation in network environments using dynamic engine.

In one aspect, a system for anomaly detection and remediation in network environments using dynamic engine is provided. In some embodiments, the system may comprise a memory device with computer-readable program code stored thereon; at least one processing device, wherein executing the computer-readable program code is configured to cause the at least one processing device to execute the computer-readable program code to: receive and extract network data from one or more distributed networks; identify one or more distributed network data domains based on the network data; generate a network attribute set based on at least the one or more distributed network data domains, wherein the network attribute set comprises network attributes; determine, using a dynamic engine, one or more thresholds associated with the one or more network attributes; identify, using the dynamic engine, one or more network anomalies based on at least the one or more thresholds associated with the one or more network attributes; and transmit an anomaly alert notification, wherein the anomaly alert comprises the one or more network anomalies.

In some embodiments, the one or more thresholds further comprises: at least one of a downstream chain threshold, lateral dispersion threshold, recursive frequency threshold, network data aggregation threshold, and convolution threshold.

In some embodiments, executing the computer-readable program code is further configured to cause the at least one processing device to: determine, using the dynamic engine, a network node threshold associated with the one or more distributed networks determine, using the dynamic engine, one or more network nodes associated with the one or more thresholds; and execute, using the dynamic engine, a network anomaly scan based on at least the network node threshold and the one or more network nodes associated with the one or more thresholds.

In some embodiments, executing the computer-readable program code is further configured to cause the at least one processing device to: segment the one or more network nodes based on the network anomaly scan; intercept network traffic transmitted to the one or more nodes; determine, using the dynamic engine, one or more alternate nodes; and retransmit network traffic to the one or more alternate nodes.

In some embodiments, executing the computer-readable program code is further configured to cause the at least one processing device to: determine, using the dynamic engine, a local network anomaly remediation based on at least the network anomaly scan; determine, using the dynamic engine, a macro network anomaly remediation based on at least the network anomaly scan and the one or more thresholds; and transmit the local network anomaly remediation and the macro network anomaly remediation.

In some embodiments, executing the computer-readable program code is further configured to cause the at least one processing device to: execute, using the dynamic engine, the local network anomaly remediation, wherein the local network anomaly remediation is associated with the one or more network anomalies associated with the one or more network nodes; and execute, using the dynamic engine, the macro network anomaly remediation, wherein the macro network anomaly remediation comprises the network node threshold associated with the one or more distributed networks.

In some embodiments, executing the computer-readable program code is further configured to cause the at least one processing device to: generate a user interface on a display; render one or more interactive interface elements within the user interface, wherein the one or more interactive interface elements are associated with the one or more network anomalies; and receive control signals from at least one device to modify the one or more interactive interface elements.

In some embodiments, executing the computer-readable program code is further configured to cause the at least one processing device to: receive at least one historical dataset; train the dynamic engine based on the at least one historical dataset; receive network packet anomaly data; update the at least one historical dataset with the network packet anomaly data; and retrain the dynamic engine based on the network packet anomaly data.

In some embodiments, executing the computer-readable program code is further configured to cause the at least one processing device to: generate, using the dynamic engine, an alternative network node chain based on the one or more network anomalies; transmit network transmissions to the alternative network node chain; and execute a transmission verification based on the network transmissions.

In some embodiments, executing the computer-readable program code is further configured to cause the at least one processing device to: determine, using the dynamic engine, a forecast network anomaly based on the network data, network attribute set, one or more distributed network data domains, one or more thresholds, and the one or more network anomalies; and generate, using the dynamic engine, forecast network anomaly remediations based on the forecast network anomaly.

In another aspect, a computer program product for anomaly detection and remediation in network environments using dynamic engine, wherein the computer program product comprises at least one non-transitory computer-readable medium having computer-readable program code portion embodied therein, the computer-readable program code portions which when executed by a processing device are configured to cause a processor to: receive and extract network data from one or more distributed networks; identify one or more distributed network data domains based on the network data; generate a network attribute set based on at least the one or more distributed network data domains, wherein the network attribute set comprises network attributes; determine, using a dynamic engine, one or more thresholds associated with the one or more network attributes; identify, using the dynamic engine, one or more network anomalies based on at least the one or more thresholds associated with the one or more network attributes; and transmit an anomaly alert notification, wherein the anomaly alert comprises the one or more network anomalies.

In some embodiments, the one or more thresholds further comprises: at least one of a downstream chain threshold, lateral dispersion threshold, recursive frequency threshold, network data aggregation threshold, and convolution threshold.

In some embodiments, the processing device is further configured to: determine, using the dynamic engine, a network node threshold associated with the one or more distributed networks; determine, using the dynamic engine, one or more network nodes associated with the one or more thresholds; and execute, using the dynamic engine, a network anomaly scan based on at least the network node threshold and the one or more network nodes associated with the one or more thresholds.

In some embodiments, the processing device is further configured to: segment the one or more network nodes based on the network anomaly scan; intercept network traffic transmitted to the one or more nodes; determine, using the dynamic engine, one or more alternate nodes; and retransmit network traffic to the one or more alternate nodes.

In some embodiments, the processing device is further configured to: determine, using the dynamic engine, a local network anomaly remediation based on at least the network anomaly scan; determine, using the dynamic engine, a macro network anomaly remediation based on at least the network anomaly scan and the one or more thresholds; and transmit the local network anomaly remediation and the macro network anomaly remediation.

In some embodiments, the processing device is further configured to: execute, using the dynamic engine, the local network anomaly remediation, wherein the local network anomaly remediation is associated with the one or more network anomalies associated with the one or more network nodes; and execute, using the dynamic engine, the macro network anomaly remediation, wherein the macro network anomaly remediation comprises the network node threshold associated with the one or more distributed networks.

In some embodiments, the processing device is further configured to: generate, using the dynamic engine, an alternative network node chain based on the one or more network anomalies; transmit network transmissions to the alternative network node chain; and execute a transmission verification based on the network transmissions.

In some embodiments, the processing device is further configured to: determine, using the dynamic engine, a forecast network anomaly based on the network data, network attribute set, one or more distributed network data domains, one or more thresholds, and the one or more network anomalies; and generate, using the dynamic engine, forecast network anomaly remediations based on the forecast network anomaly.

In another aspect, a computer-implemented method for anomaly detection and remediation in network environments using dynamic engine: receiving and extracting network data from one or more distributed networks; identifying one or more distributed network data domains based on the network data; generating a network attribute set based on at least the one or more distributed network data domains, wherein the network attribute set comprises network attributes; determining, using a dynamic engine, one or more thresholds associated with the one or more network attributes; identifying, using the dynamic engine, one or more network anomalies based on at least the one or more thresholds associated with the one or more network attributes; and transmitting an anomaly alert notification, wherein the anomaly alert comprises the one or more network anomalies.

In some embodiments, the computer-implemented method is further configured for: determining, using the dynamic engine, a network node threshold associated with the one or more distributed networks determining, using the dynamic engine, one or more network nodes associated with the one or more thresholds; and executing, using the dynamic engine, a network anomaly scan based on at least the network node threshold and the one or more network nodes associated with the one or more thresholds.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrate technical components of an exemplary distributed computing environment for anomaly detection and remediation in network environments using dynamic engine, in accordance with an embodiment of the disclosure;

FIG. 2 illustrates an exemplary AI engine subsystem architecture, in accordance with an embodiment of the disclosure;

FIG. 3 illustrates an exemplary generative AI engine subsystem architecture, in accordance with an embodiment of the disclosure;

FIG. 4 illustrates a process flow for anomaly detection and remediation in network environments using dynamic engine, in accordance with an embodiment of the disclosure, in accordance with an embodiment of the disclosure;

FIG. 5 illustrates a process flow for executing a network anomaly scan, in accordance with an embodiment of the disclosure;

FIG. 6 illustrates a process flow for determining one or more alternate nodes using the dynamic engine, in accordance with an embodiment of the disclosure;

FIG. 7 illustrates a process flow for determining and transmitting network anomaly remediations, in accordance with an embodiment of the disclosure;

FIG. 8 illustrates a process flow for executing network anomaly remediations, in accordance with an embodiment of the disclosure;

FIG. 9 illustrates a process flow for rendering and modifying one or more interactive interface elements, in accordance with an embodiment of the disclosure;

FIG. 10 illustrates a process flow for training and retraining the dynamic engine, in accordance with an embodiment of the disclosure, in accordance with an embodiment of the disclosure;

FIG. 11 illustrates a process flow for generating an alternative network node chain, in accordance with an embodiment of the disclosure; and

FIG. 12 illustrates a process flow for forecasting network anomalies and generating remediations, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, this data may be related to the people who work for the organization, its products or services, the customers, or any other aspect of the operations of the organization. As such, the entity may be any institution, group, association, financial institution, establishment, company, union, authority, or the like, employing information technology resources for processing large amounts of data.

As described herein, a “user” may be an individual associated with an entity. As such, in some embodiments, the user may be an individual having past relationships, current relationships, or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface may include a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that may be used to identify a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure, and positioning (e.g., distal phalanges, intermediate phalanges, proximal phalanges, and the like)), an answer to a security question, a unique intrinsic user activity (e.g., making a predefined motion with a user device), and/or the like. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources input by the plurality of users within the system. The system may further use its authentication servers to certify the identity of users of the system, such that other users may verify the identity of the certified users. In some embodiments, the entity may certify the identity of the other users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (e.g., rotationally coupled, pivotally coupled, or the like). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. For purposes of this disclosure, a resource is typically stored in a resource repository—a storage location where one or more resources are organized, stored, and retrieved electronically using a computing device.

As used herein, a “resource transfer,” “resource distribution,” or “resource allocation” may refer to any transactions, activities, or communications between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, adding new accounts, opening new accounts, adding or modifying account parameters/restrictions, modifying a payee list associated with one or more accounts, setting up automatic payments, performing/modifying authentication procedures and/or credentials, modifying parameters associated with the one or more distributed network data domains, and/or the like.

Accordingly, the present disclosure is directed to anomaly detection and remediation in network environments using a dynamic engine. The present disclosure is directed to utilize a dynamic engine for management of network environments, network anomaly detection, and determining network anomaly remediations, wherein the dynamic engine may comprise an artificial intelligence (AI) engine and/or intelligent analytics engine. Furthermore, the present disclosure is configured to determine distributed network data domains, which comprise criteria specific to a distributed environment, to determine a network attribute set. In addition, the present disclosure is configured to utilize the network attribute set, such as parameters, to determine thresholds associated with network anomalies, network performance, and network security to identify one or more network anomalies. The dynamic engine also may determine anomalies in localized network nodes and global network nodes, as well as determine remediations to mitigate such anomalies. By identifying and remediating anomalies at a local and global scale, the present disclosure is configured to address security, performance, and network data management anomalies in individual network nodes, network node chains, and large scale, linked network node chains. While the present disclosure is configured to mitigate identified network anomalies, the present disclosure is also configured to segment network nodes impacted by anomalies, redirect network traffic, and generate new network nodes as required to ensure continuity of network performance.

What is more, the present disclosure provides a technical solution to a technical problem. As described herein, the technical problem includes anomaly detection and remediation in network environments using dynamic engine. The technical solution presented herein allows for allows for dynamic, intelligent, network data packet monitoring, network anomaly detection, and remediation actions generated by a dynamic engine. In particular, includes anomaly detection and remediation in network environments using dynamic engine is an improvement over existing solutions to the technical challenges, (i) with fewer steps to achieve the solution, thus reducing the amount of computing resources, such as processing resources, storage resources, network resources, and/or the like, that are being used (e.g., utilizing distributed network data domains, network attribute, and dynamic engine to identify thresholds, anomalies, and remediations), (ii) providing a more accurate solution to problem, thus reducing the number of resources required to remedy any errors made due to a less accurate solution (e.g., identifying localized network anomalies and global network anomalies and generating remediation actions to address both types of anomalies), (iii) removing manual input and waste from the implementation of the solution, thus improving speed and efficiency of the process and conserving computing resources (e.g., by utilizing the dynamic engine for continuous anomaly detection, generating anomaly remediation recommendations, and executing mitigating responsive actions), (iv) determining an optimal amount of resources that need to be used to implement the solution, thus reducing network traffic and load on existing computing resources (e.g., by leveraging intelligent analytics via the dynamic engine to proactively address anomalies locally at nodes or globally across network chains and large-scale network chains). Furthermore, the technical solution described herein uses a rigorous, computerized process to perform specific tasks and/or activities that were not previously performed. In specific implementations, the technical solution bypasses a series of steps previously implemented, thus further conserving computing resources.

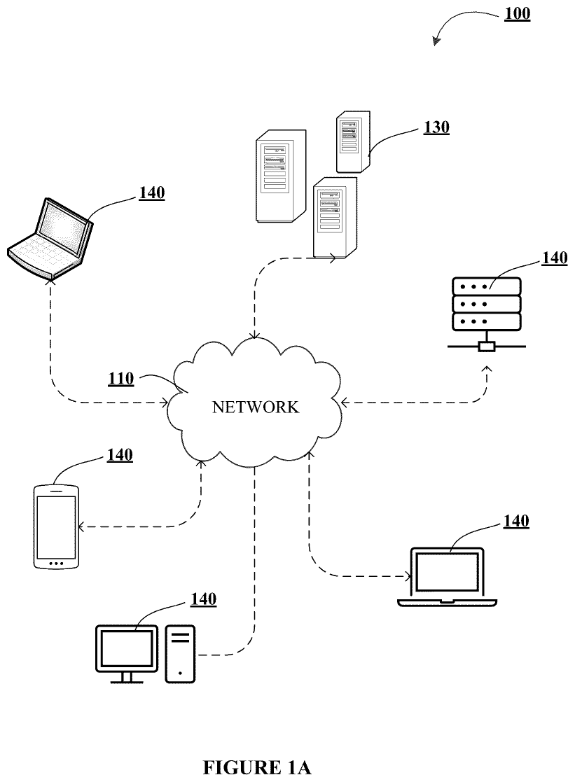

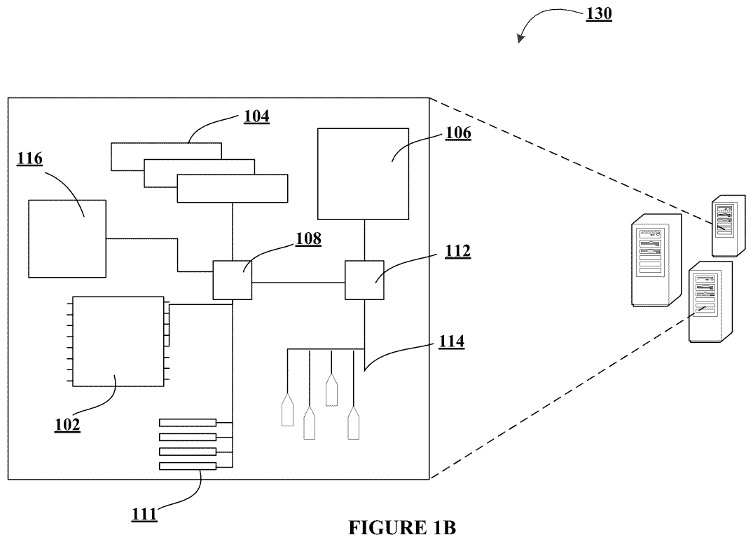

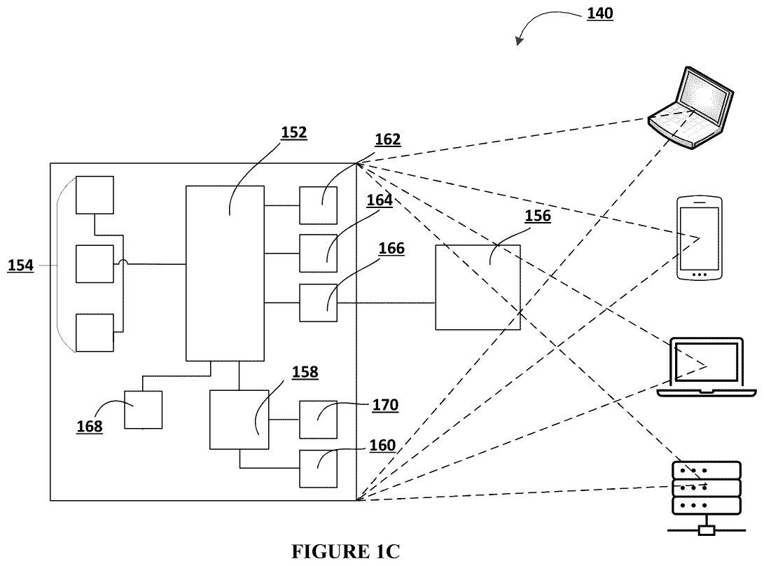

FIGS. 1A-1C illustrate technical components of an exemplary distributed computing environment for anomaly detection and remediation in network environments using dynamic engine 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connected to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which may be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 connecting to low-speed bus 114 and storage device 106. Each of the components 102, 104, 106, 108, 112 and 114 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, such as those described above. The information carrier may be a non-transitory computer- or machine-readable storage medium, such as the memory 104, the storage device 106, or memory on processor 102.

The high-speed interface 108 manages bandwidth-intensive operations for the system 130, while the low-speed interface/controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, the low-speed interface/controller 112 is coupled to storage device 106 and low-speed bus/expansion port 114. The low-speed bus/expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 166 may comprise appropriate circuitry and may be configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 may be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier may be a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through the communication interface 158, which may include digital signal processing circuitry where necessary. The communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, a GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using an audio codec 162, which may receive spoken information from a user and convert the spoken information to usable digital information. The audio codec 162 may likewise generate audible sound for a user, such as through a speaker (e.g., in a handset of end-point device(s) 140). Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described herein may be realized in digital electronic circuitry, integrated circuitry, specially designed ASICs (application specific integrated circuits), computer hardware, firmware, software, and/or combinations thereof.

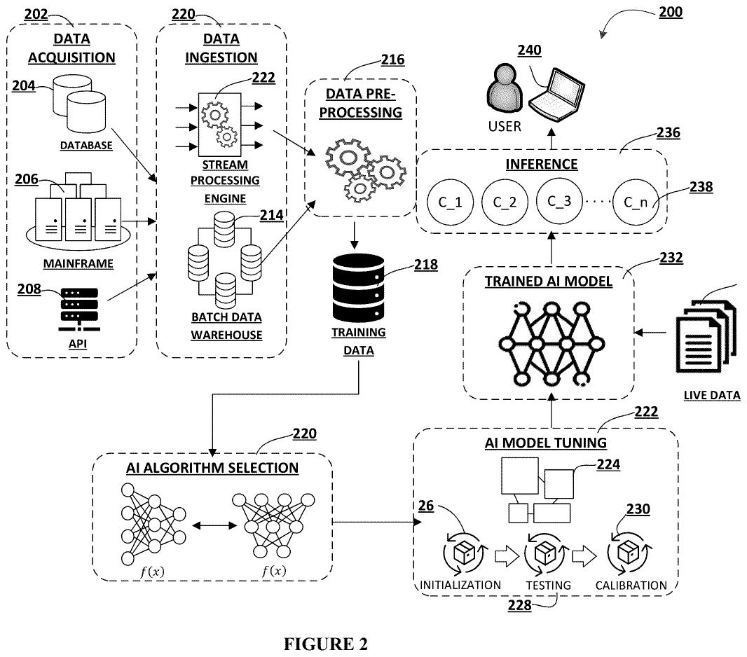

FIG. 2 illustrates an exemplary AI engine subsystem architecture 200, in accordance with an embodiment of the disclosure. The artificial intelligence subsystem 200 may include a data acquisition engine 202, data ingestion engine 210, data pre-processing engine 216, AI tuning engine 222, and inference engine 236.

The data acquisition engine 202 may identify various internal and/or external data sources to generate, test, and/or integrate new features for training the artificial intelligence model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including Rational Database Management Systems (RDBMs), other types of databases, Simple Storage System (S3) buckets, Comma Separated Values (CSVs), or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence model 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so an artificial intelligence model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI tuning engine 222 may be used to train an artificial intelligence engine 224 using the training data 218 to make predictions or decisions without explicitly being programmed to do so. The artificial intelligence engine 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable artificial intelligence model type. Each of these types of artificial intelligence algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the artificial intelligence model, the Machine Learning (ML) model tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained artificial intelligence model 232 is one whose hyperparameters are tuned and model accuracy maximized.

The trained artificial intelligence model 232, similar to any other software application output, can be persisted to storage, file, memory, or application, or looped back into the processing component to be reprocessed. More often, the trained artificial intelligence model 232 is deployed into an existing production environment to make practical business decisions based on live data 234. To this end, the artificial intelligence subsystem 200 uses the inference engine 236 to make such decisions. The type of decision-making may depend upon the type of artificial intelligence algorithm used. For example, artificial intelligence models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, artificial intelligence models that perform regression techniques may use live data 234 to predict or forecast continuous outcomes.

It will be understood that the embodiment of the artificial intelligence subsystem 200 illustrated in FIG. 2 is exemplary and that other embodiments may vary. As another example, in some embodiments, the artificial intelligence subsystem 200 may include more, fewer, or different components.

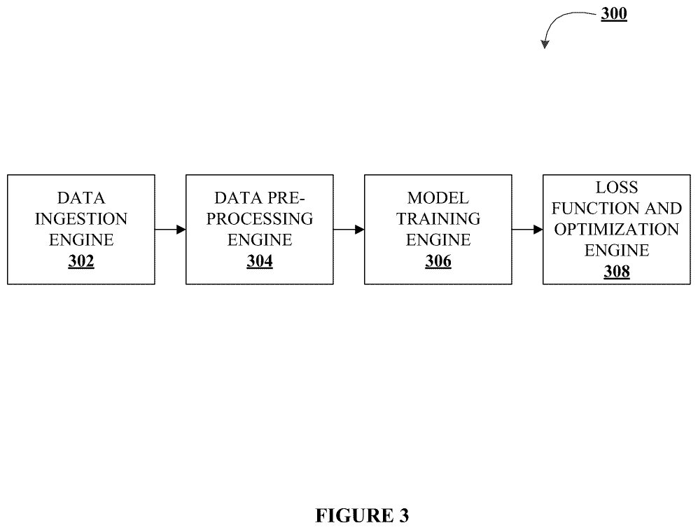

FIG. 3 illustrates an exemplary generative AI subsystem 300, in accordance with an embodiment of the invention. The generative AI subsystem 300 may include a data ingestion engine 302, a data pre-processing engine 304, and a model training engine 306. It should be understood that the generative AI subsystem 300 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 300 should not be considered limiting and may be adapted to various configurations within the scope of the invention.

The data ingestion engine 302 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 302 may support decentralized storage systems, such as blockchain-based data sources, and privacy-preserving methods such as differential privacy. The data ingestion engine 302 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like.

Depending on the nature of the data, the data ingestion engine 302 may move the data to a destination for storage or further analysis. Typically, the data may be in varying formats as they come from different sources, including RDBMS, other types of databases, S3 buckets, CSVs, or from streams. For a Large Language Model (LLM), text data may originate from sources such as web scrapes, social media, large public text datasets, or the like. Since the data comes from different places, it needs to be cleansed and transformed so that it can be analyzed together with data from other sources. The data may be ingested in real-time, using stream processing, in batches using a batch data warehouse, or a combination of both. Stream processing may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse collects and transfers data in batches according to scheduled intervals, trigger events, or any other logical ordering.

In Machine Learning (ML), the quality of data and the useful information that can be derived therefrom directly affects the ability of the machine learning model to learn. The data pre-processing engine 304 may implement advanced integration and processing steps needed to prepare the data for machine learning execution, including tokenization, text normalization, and removal of irrelevant elements like HTML tags in web-based data, especially for LLM training. This may include modules to perform any upfront, data transformation to consolidate the data into alternate forms by changing the value, structure, or format of the data using generalization, normalization, attribute selection, and aggregation, text-specific transformations such as stemming and lemmatization, data cleaning by filling missing values, smoothing the noisy data, resolving the inconsistency, and removing outliers, and/or any other encoding steps as needed. In some embodiments, the data pre-processing engine 304 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 304 may transform categorical data into numerical formats that are suitable for machine learning algorithms. In this regard, the data pre-processing engine 304 may use techniques such as one-hot encoding or label encoding depending on the nature of the categorical variables and the intended use of the data.

In some embodiments, the data pre-processing engine 304 may also include dimensionality reduction techniques, where the number of input features is reduced while retaining the most relevant information. In this regard, the data pre-processing engine 304 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 304 may then be fed into the model training module 306.

The model training engine 306 may be responsible for training the generative AI models using the pre-processed data from the data pre-processing engine 304. The model training engine 306 may implement various machine learning algorithms, including but not limited to Generative Adversarial Networks (GANs), Variational Autoencoders (VAEs), transformers, diffusion models, or other specialized architectures depending on the specific requirements of the system. These models may be used in a broad range of applications, such as LLMs for text generation, image generation models, video synthesis models, audio generation models, and/or the like. The model training engine 306 may optimize these models by continuously adjusting their internal parameters based on the patterns and relationships identified within the data.

In some embodiments, the model training engine 306 may include a training data handler, which manages the partitioning of the pre-processed data into training, validation, and testing datasets. The training data is used to update the model's parameters, while the validation and testing datasets are reserved to evaluate the model's performance during and after training. The model training engine 306 may support various data-handling strategies, such as cross-validation or random shuffling, to ensure that the model generalizes well and is not overfitting to the training data.

In embodiments involving large language models, the model training engine 306 may utilize transformer-based architectures, such as the Transformer, Bidirectional Encoder Representations from Transformers (BERT), Generative Pre-trained Transformer (GPT), or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to manage tasks such as summarization, translation, and text generation. Loss functions like cross-entropy loss may be used to optimize the model's performance by comparing predicted tokens with the actual tokens in the dataset to guide the model to minimize prediction errors during training, as described in further detail herein.

In embodiments involving image generation models, the model training engine 306 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine 306 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 306 may utilize architectures such as Audio Transformers or Recurrent Neural Networks (RNNs) like WaveNet, designed to manage sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL (Kullback-Liebler) divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 306, which includes an optimization module 308, may implement various optimization techniques to improve model performance and efficiency. The optimization module 308 is responsible for adjusting the model's internal parameters continuously, using feedback from relevant loss functions tailored to the application (e.g., text, image, audio, or video generation). Techniques such as gradient clipping, learning rate scheduling, and mixed-precision training are applied by the optimization module 308 to stabilize and fine-tune the training process. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In some embodiments, the model training engine 306 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 306 may also support distributed training across multiple computing nodes, allowing the system to scale its computational resources as needed. Distributed training may involve splitting the generative AI model and data across multiple machines or Graphical Processing Units (GPUs), where each node processes a portion of the data and updates the model in parallel. This is particularly useful for large datasets or models that require significant computational power, such as deep generative models. The model training engine 306 may synchronize the updates across the nodes using techniques like synchronous or asynchronous gradient descent.

Once the generative AI model is trained, the model training engine 306 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 306 may also implement transfer learning, where a pre-trained model is fine-tuned on a smaller, domain-specific dataset. This may reduce the amount of time and data required to train a new model, especially in cases where the available data is limited or highly specialized. The model training engine 306 may adjust the parameters of the pre-trained model to better align with the new dataset, while preserving the learned features from the original training.

In embodiments involving LLMs, new output is generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters such as heat, which influences the randomness of the token sampling, enabling the generation of diverse or deterministic responses.

In image generation models, such as those using ViTs or GANs, new output is generated by sampling from the learned distribution in the model's latent space. For GANs, the generator network creates an image by transforming random noise vectors into structured image outputs through a series of layers that learn visual features like shapes, textures, and colors. The generated image is then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors, or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures like WaveNet, generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some embodiments, generative AI models may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the embodiment of the generative AI subsystem 300 illustrated in FIG. 3 is exemplary and that other embodiments may vary. The generative AI subsystem 300, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

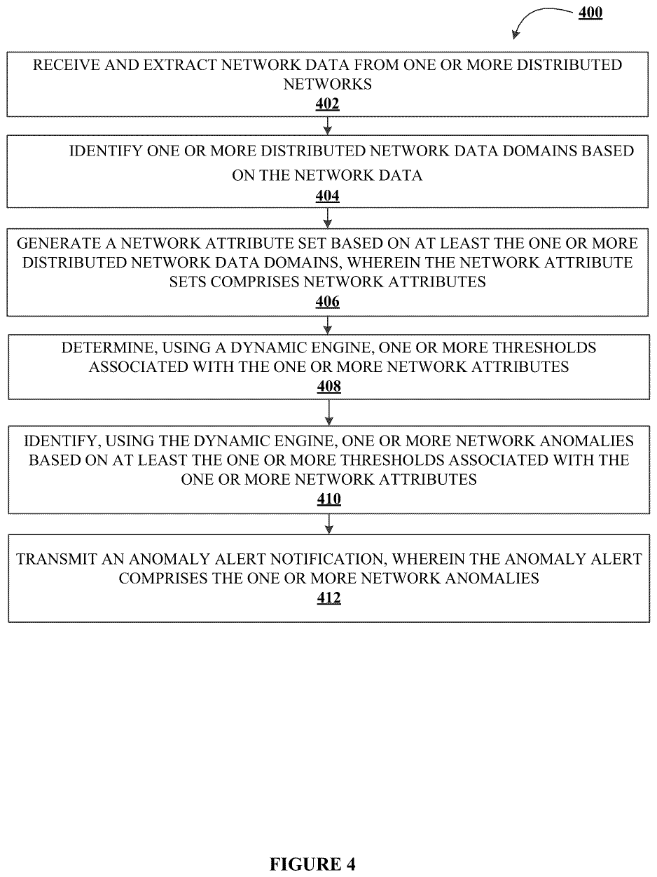

FIG. 4 illustrates a process flow 400 for anomaly detection and remediation in network environments using dynamic engine, in accordance with an embodiment of the disclosure. In some embodiments, a system (e.g., similar to one or more of the systems described herein with respect to FIGS. 1A-1C) may perform one or more of the steps of process flow 400. For example, an anomaly detection and remediation in network environments using dynamic engine system (e.g., the system 130 described herein with respect to FIGS. 1A-1C) may perform the steps of process flow 400. In some embodiments, an AI engine (e.g., such as the AI engine like that described in FIG. 2) or a generative AI subsystem (e.g., such as the generative AI subsystem described in FIG. 3) may perform some or all of the steps described in process flow 400.

As shown in block 402, the process flow 400 may include the step of receiving and extracting network data from one or more distributed networks. In some embodiments of the disclosure, the system, dynamic engine, artificial intelligence (AI) engine, and/or the like may receive and extract the network data dynamically, continuously, via on-demand trigger, via batch processing, and/or the like. In some embodiments of the disclosure, the one or more distributed networks may comprise one or more network environments, software-defined networks, distributed ledgers, nested distributed ledgers, peer-to-peer networks, and/or the like. In some embodiments, an Extract, Transform, and Load (ETL) process may be utilized to receive the network data from the one or more distributed networks, process the extracted network data, and then store the extracted network data in an internal data storage repository.

The network data may comprise network data packets, distributed ledger network data packets, metadata associated with network data, and/or the like, according to some embodiments. According to some embodiments, the network data may comprise a network file, memory location of a repository, unique identification number, network transaction metadata, network transmission sender data (e.g., IP address for one or more network devices, accounts associated with the network transmission sender, reference address associated with the network transmission sender, and/or network resource account associated with the network transmission sender), network transmission receiver data (e.g., IP address for the one or more network devices, accounts associated with the network transmission recipient, reference address associated with the network transmission recipient, and/or network resource account associated with the network transmission recipient), metadata associated with the network transmission, network transmission bandwidth requirements, network transmission data security requirements, network transmission identifier data (e.g., unique identification data), digital signature, security certificate, cryptographic signature, analytics associated with network traffic, and/or the like.

As shown in block 404, the process flow 400 may include the step of identifying one or more distributed network data domains based on the network data. According to some embodiments, the dynamic engine, AI engine, and/or system may identify the one or more distributed network data domains dynamically, continuously, via on-demand trigger, via batch processing, and/or the like. In some embodiments, the one or more distributed network data domains may comprise criteria for categorizing and/or aggregating the network data, such as in a repository (e.g., database, data lake, data warehouse, distributed ledger, network node, data block, network node chain, and/or the like). According to some embodiments, the one or more distributed network data domains may comprise criteria associated with network operations (e.g., latency, bandwidth, data security, authentication, security certificates, device authorization, anomaly detection, data management, data labels, and/or the like), verification criteria for one or more network nodes and/or network devices, network status criteria, known network anomalies, network traffic patterns, network router validation, network switch validation, firewall validation, firewall authorization, server validation, encryption criteria, data security requirements, execution speed requirements, authorization requirements, authentication methods, quality of service, network device compatibility, data redundancy requirements, access controls, scalability, and/or the like. According to some embodiments, the one or more distributed network data domains may be associated with the one or more distributed networks, network environments, distributed ledgers, subnets, network devices, network transactions, and/or the like.

As shown in block 406, the process flow 400 may include the step of generating a network attribute set based on at least the one or more distributed network data domains, wherein the network attribute set comprises network attributes. In some embodiments, the dynamic engine, AI engine, system, and/or the like may generate the network attribute set dynamically, continuously, via on-demand trigger, via batch processing, and/or the like. The network attribute set may be predetermined, determined by a device associated with a user, and/or the like, according to some embodiments.

According to some embodiments, the network attributes may comprise downstream threads (e.g., determining network data thread length and/or recursive reference network data chains to identify longest network data threads and/or depth of linking and nesting of network data threads), lateral dispersion (e.g., determining linkage multiplicity of network data within one or more network data sets, network data blocks, and/or the like), recursive frequency (e.g., anomalous recursive references and interlacing within the network data threads, network datasets, and/or the like), network data aggregation (e.g., memory and/or resource consumption associated with network data abundance within one or more network data blocks), convolution (e.g., complexity associated with verifying network transmissions due to duplicative network data contained in at least two network datasets), network data threads, nested network data threads, linked network data threads, anomalous network data thread recursive references, network data thread recursion, network data aggregation, and/or network data thread convolution.

As shown in block 408, the process flow 400 may include the step of determining, using a dynamic engine, one or more thresholds associated with the one or more network attributes. In some embodiments, the one or more thresholds may be determined dynamically, continuously, via on-demand trigger, via batch processing, and/or the like. According to some embodiments of the disclosure, the dynamic engine, which may comprise an AI engine and/or intelligent analytics engine, may determine the one or more thresholds in parallel or series, depending upon resource utilization, bandwidth, network transmission size, and/or the like.

According to some embodiments, the one or more thresholds associated with the one or more network attributes may comprise downstream chain threshold (e.g., threshold associated with network data thread length, recursive reference network data chains, and/or depth of linking and nesting of network data threads), lateral dispersion threshold (e.g., threshold associated with linkage multiplicity of network data within one or more network data sets, network data blocks, and/or the like), recursive frequency threshold (e.g., threshold associated with anomalous recursive references and interlacing within the network data threads, network datasets, and/or the like), network data aggregation threshold (e.g., threshold associated with memory and/or resource consumption associated with data abundance within one or more network data blocks), convolution threshold (e.g., threshold associated with complexity associated with verifying network transmissions due to duplicative network data contained in at least two network datasets), data security threshold (e.g., threshold associated with data security requirements and/or management), security incident threshold (e.g., threshold associated with network security breaches, compromised data repositories, ransomware, social engineering, malware, and/or the like), latency threshold (e.g., threshold associated with latencies detected within the one or more distributed networks), network bandwidth threshold (e.g., threshold associated with network data transmission rates over available network connections within the one or more distributed networks), and/or authentication threshold (e.g., threshold associated with authentications, wherein authentication may comprise credentials, one-time password, physical factor authentication, multi-factor authentication, authentication app, network access controls, application access provisioning, token authentication, and/or the like).

In some embodiments, the one or more thresholds may be evaluated in combination to yield a global anomaly threshold, wherein the global anomaly threshold comprises at least two of the downstream chain threshold, lateral dispersion threshold, recursive frequency threshold, network data aggregation threshold, convolution threshold, data security threshold, security incident threshold, latency threshold, network bandwidth threshold, and/or authentication threshold. By way of non-limiting example, and in some embodiments, the dynamic engine may determine a total of units, network devices, network nodes, network edges, data blocks, network data thread units, and/or data repositories within the one or more distributed networks to generate a global network data unit metric. Furthermore, the dynamic engine may determine a numerical total of units, network devices, network nodes, network edges, data blocks, network data thread units, and/or data repositories associated with each of the downstream chain threshold, lateral dispersion threshold, recursive frequency threshold, network data aggregation threshold, convolution threshold, data security threshold, security incident threshold, latency threshold, network bandwidth threshold, and/or authentication threshold to generate one or more localized network data metrics.

In addition, the dynamic engine may determine the global anomaly threshold based on the global network data unit metric and/or the one or more localized network data metrics. In some embodiments, the global anomaly threshold may comprise a qualitative descriptor, quantitative value, and/or the like, in some embodiments. In some embodiments, the qualitative descriptor may comprise a letter grade (e.g., A to F), a written description (e.g., high, medium, low, and/or the like), and/or the like. In some embodiments, the quantitative value may comprise a numerical rating (e.g., whole number, decimals, and/or the like) on a spectrum (e.g., from zero to one). According to some embodiments, a quantitative value with a lower rating on the spectrum (e.g., approaching zero) may be associated with a higher threat level and a quantitative value with a higher rating on the spectrum (e.g., approaching one) may be associated with a lower threat level. In some embodiments, a quantitative value at least equal to the maximum value on the spectrum may be associated with a nominal threat level due to the relative lack of complexity within the nodes, network data threads, network data paths, data blocks, and/or the like in the one or more distributed networks.

As shown in block 410, the process flow 400 may include the step of identifying, using the dynamic engine, one or more network anomalies based on at least the one or more thresholds associated with the one or more network attributes. In some embodiments, the dynamic engine may identify the one or more network anomalies based on the one or more thresholds associated with the one or more network attributes, the global anomaly threshold, global network data unit metric, and/or one or more localized network data metrics.

According to some embodiments, the dynamic engine may compare the network attribute set and/or the one or more thresholds to one or more predetermined threat levels, wherein the one or more predetermined threat levels are criteria associated with the one or more distributed network data domains. In such configurations, and in some embodiments, a network anomaly may be detected if the network attribute set, is lower than, exceeds, and/or equal to the one or more predetermined threat levels and/or one or more thresholds. By way of a non-limiting example, and in some embodiments, the dynamic engine evaluates the one or more distributed network data domains to generate corresponding one or more predetermined threat levels and/or one or more thresholds, determine the network attribute set, and determines if a network anomaly is present based on a comparison of the network attribute set and the one or more predetermined threat levels and/or one or more thresholds. In some embodiments, the dynamic engine may analyze logs associated with the one or more distributed networks to detect abnormal traffic patterns in network data transmissions between network devices, failed authorization attempts, failed consensus authentication, rejected network transactions, and/or the like. By leveraging a dynamic engine, which may comprise an AI engine and/or intelligent analytics engine, the system improves the security of the network environment by detecting one or more anomalies based upon dynamic threshold and criteria determinations.

As shown in block 412, the process flow 400 may include the step of transmitting an anomaly alert notification, wherein the anomaly alert comprises the one or more network anomalies. In some embodiments, the dynamic engine may generate and/or transmit the anomaly alert notification. In some embodiments, the anomaly alert notification may comprise a communication transmission, wherein the communication transmission may comprise text data, audio data, visual data, and/or the like. In some embodiments, the anomaly alert notification may be transmitted via an ETL process, transmitted to a network device, and/or transmitted to a user device associated with at least one network user via push notification. According to some embodiments, the AI engine may generate network anomaly remediation actions based on the one or more network anomalies and transmit the network anomaly remediation actions via the anomaly alert notification and/or via a secondary notification.

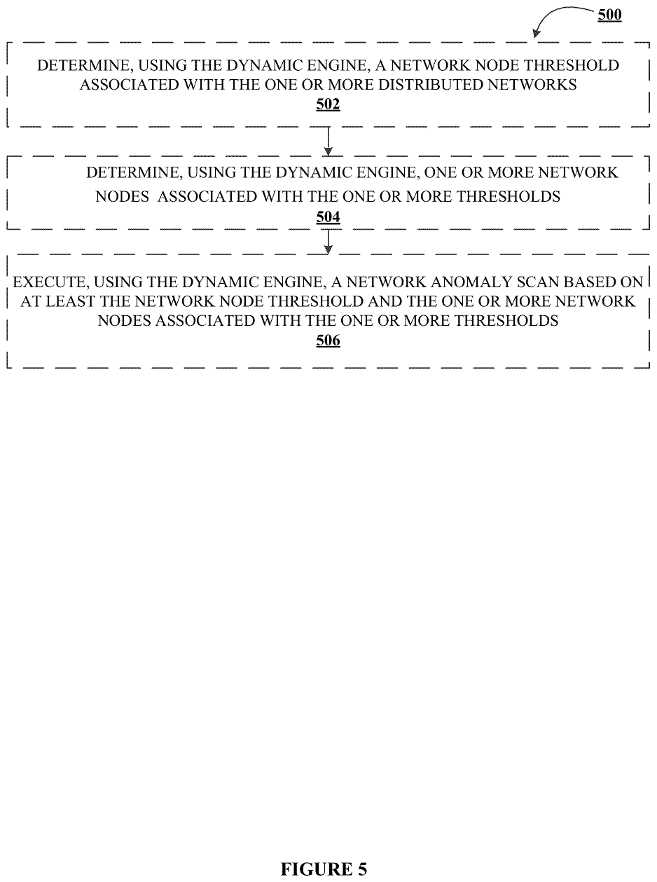

FIG. 5 illustrates a process flow 500 for executing a network anomaly scan, in accordance with an embodiment of the disclosure. In some embodiments, a system (e.g., similar to one or more of the systems described herein with respect to FIGS. 1A-1C) may perform one or more of the steps of process flow 500. For example, an anomaly detection and remediation in network environments using dynamic engine system (e.g., the system 130 described herein with respect to FIGS. 1A-1C) may perform the steps of process flow 500. In some embodiments, an AI engine (e.g., such as the AI engine like that described in FIG. 2) or a generative AI subsystem (e.g., such as the generative AI subsystem described in FIG. 3) may perform some or all of the steps described in process flow 500.

As shown in block 502, the process flow 500 may include the step of determining, using the dynamic engine, a network node threshold associated with the one or more distributed networks. The dynamic engine may determine the network node threshold continuously, dynamically upon a trigger (e.g., via user request, upon instance of anomaly detection, and/or the like), and/or via batch processing at predetermined intervals.

According to some embodiments, the network node threshold associated with the one or more distributed networks may comprise a network node security threshold (e.g., threshold associated with encryption, firewalls, network authentication, consensus algorithms, secure routing protocols, antivirus applications, and/or the like), downstream chain threshold, lateral dispersion threshold, recursive frequency threshold, network data aggregation threshold, convolution threshold, data security threshold, security incident threshold, latency threshold, network bandwidth threshold, and/or authentication threshold. According to some embodiments, the network node threshold may be determined by the dynamic engine in series and/or parallel with other threshold determinations made by the dynamic engine. In some embodiments, the network node threshold may comprise a threat threshold associated with network traffic routing (e.g., routing traffic amongst various network devices, network paths, and/or the like) and/or network path redundancy (e.g., providing redundant paths to safeguard against fault tolerances). In some embodiments, the network node threshold may comprise a threat threshold associated with network devices, network edges, end nodes, distributed nodes, peer-to-peer nodes, and/or hierarchical nodes within the one or more distributed networks.

According to some embodiments, the network node threshold may comprise a total of units, network devices, network nodes, network edges, data blocks, network data thread units, distributed ledgers, distributed ledger blocks, network chains, nested network chains, recursive network chains, network paths, network data chains, and/or data repositories within the network environments, one or more distributed networks and/or the like (“global nodes”). In such a configuration, and in some embodiments, the dynamic engine may initiate a network scan of the one or more distributed networks to determine the network node threshold by generating a log of all detected global nodes. In some embodiments, the log may comprise IP addresses associated with detected global nodes, timestamps, detected anomalies, suspicious traffic, and/or the like.

In some embodiments, the network node threshold may comprise a qualitative descriptor, quantitative value, and/or the like. In some embodiments, the qualitative descriptor may comprise a letter grade (e.g., A to F), a written description (e.g., high, medium, low, and/or the like), and/or the like. In some embodiments, the quantitative value may comprise a numerical rating (e.g., whole number, decimals, and/or the like) on a spectrum (e.g., from zero to one). According to some embodiments, a quantitative value with a lower rating on the spectrum (e.g., approaching zero) may be associated with a higher threat level and a quantitative value with a higher rating on the spectrum (e.g., approaching one) may be associated with a lower threat level. In some embodiments, a quantitative value at least equal to the maximum value on the spectrum may be associated with a nominal threat level due to the relative lack of complexity within the nodes, network data threads, network data paths, data blocks, and/or the like in the one or more distributed networks.

As shown in block 504, the process flow 500 may include the step of determining, using the dynamic engine, one or more network nodes associated with the one or more thresholds. The dynamic engine may determine the one or more network nodes associated with the one or more thresholds continuously, dynamically upon a trigger (e.g., via user request, upon instance of anomaly detection, and/or the like), and/or via batch processing at predetermined intervals, according to some embodiments.

In some embodiments, the dynamic engine may determine a numerical total of units, subunits, network devices, network nodes, network edges, data blocks, network data thread units, distributed ledgers, distributed ledger blocks, network chains, nested network chains, recursive network chains, network paths, network data chains, and/or data repositories (“localized node”) associated with each of the network node security threshold, downstream chain threshold, lateral dispersion threshold, recursive frequency threshold, network data aggregation threshold, convolution threshold, data security threshold, security incident threshold, latency threshold, network bandwidth threshold, and/or authentication threshold to generate the one or more network nodes associated with the one or more thresholds. In some embodiments, the dynamic engine may evaluate each of the localized nodes in series and/or parallel when determining the one or more network nodes associated with the one or more thresholds. By way of non-limiting example, and in some embodiments, the dynamic engine may execute a network node scan of the localized nodes to determine if each of the localized nodes exceeds, are equivalent to, and/or are below each of the one or more thresholds, based on the one or more distributed network data domains. In executing this network node scan, the dynamic engine may determine which localized nodes are associated with each of the one or more thresholds. Evaluating localized nodes in a network node chain facilitates targeted anomaly detection, and corresponding corrective responsive actions, to improve rapid anomaly detection and remediation in network environments.

As shown in block 506, the process flow 500 may include the step of executing, using the dynamic engine, a network anomaly scan based on at least the network node threshold and the one or more network nodes associated with the one or more thresholds. According to some embodiments, the dynamic engine may execute the network anomaly scan continuously, dynamically upon a trigger (e.g., via user request, upon instance of anomaly detection, and/or the like), and/or via batch processing at predetermined intervals.

In some embodiments, the network anomaly scan may be executed by a network scanner, network performance monitor, Internet Protocol (IP) scanner, the dynamic engine, and/or the like. The network anomaly scan may comprise an internal vulnerability scan, external vulnerability scan, full-assessment scan, and/or penetration test, according to some embodiments. In some embodiments, the network anomaly scan may comprise at least one subnet of one network, one or more predetermined subnets of one or more networks, and/or the like. According to some embodiments, the dynamic engine may log vulnerabilities, network anomalies, performance errors, latencies, and/or the like while executing the network anomaly scan.

In some embodiments, the network anomaly scan may comprise analyzing global nodes and/or localized nodes for potential anomalies and/or suspicious activities. By way of non-limiting example, and in some embodiments, the potential anomalies and/or suspicious activities may comprise abnormal spikes in network traffic, unauthorized access attempts, unfamiliar or unknown devices connected to the network, abnormal bandwidth usage associated with network devices; unexpected configuration changes, excessive broadcast/multicast traffic, unauthorized port access, MAC address spoofing associated with switches; routing table inconsistencies, unexpected route changes, high CPU/memory usage, unauthorized access attempts, routing loops associated with routers; denied traffic logs, failed login attempts, abnormal firewall rule changes, suspicious IP addresses or domains in logs associated with firewalls; sudden drops in performance, unexpected traffic patterns, secure socket layer (SSL) certificate issues, excessive number of connections to one or more virtual IP addresses (VIP) associated with load balancers; at least one failed authentication attempts, unauthorized access points detected, rogue access points, sudden and unexpected changes in wireless network settings associated with access points; and/or abnormal spikes in internet traffic, unauthorized VPN connections, malware-infected devices accessing the internet, and/or unusual Domain Name System (DNS) queries associated with gateways.

According to some embodiments, the network anomaly scan may comprise a network scan of the global nodes and/or localized nodes to identify network anomalies. In some embodiments, the network anomaly scan may comprise generating a network anomaly threshold based on the network node threshold and the one or more network nodes associated with the one or more thresholds. The network anomaly threshold may be based on a predetermined setting, one or more distributed network data domains, network rules, and/or the like.

According to some embodiments, the network anomaly threshold may comprise a qualitative descriptor, quantitative value, and/or the like. In some embodiments, the qualitative descriptor may comprise a letter grade (e.g., A to F), a written description (e.g., high, medium, low, and/or the like), and/or the like. According to some embodiments, the quantitative value may comprise a derived value by dividing a sum of global nodes by the sum of localized nodes. In some embodiments, the quantitative value may comprise a numerical rating (e.g., whole number, decimals, and/or the like) on a spectrum (e.g., from zero to one). According to some embodiments, a quantitative value with a lower rating on the spectrum (e.g., approaching zero) may be associated with a higher threat level and a quantitative value with a higher rating on the spectrum (e.g., approaching one) may be associated with a lower threat level. In some embodiments, a quantitative value at least equal to the maximum value on the spectrum may be associated with a nominal threat level due to the relative lack of complexity within the global nodes and/or localized nodes in the one or more distributed networks.

According to some embodiments, the dynamic engine may determine that one or more known global nodes and/or localized nodes are undetected during the network anomaly scan, log each instance of a failure to detect such nodes, determine a reason for the lack of detection, and/or transmit a notification. The failure to detect nodes may be the result of an offline node, compromised node, and/or the like, in some embodiments. The dynamic engine may execute at least one additional network anomaly scan via loop trigger to attempt to detect the undetected nodes, in some embodiments. In some embodiments, if the at least one additional network anomaly fails again to detect the known nodes, then the dynamic engine may determine the presence of at least one network anomaly and/or generate an alert. According to some embodiments, the dynamic engine may detect an unknown global node and/or localized node during the network anomaly scan and may log the detected unknown node as a network anomaly. In some embodiments, the dynamic engine may attempt to authenticate (e.g., such as via multi-factor, one-time password, authentication credentials, token, batch, trust algorithm, and/or the like) the detected unknown node to determine if a detected unknown node is a trusted node. If the authentication attempt fails, then the dynamic engine may determine that the detected unknown node is a network anomaly. The system provides enhanced anomaly detection by determining if expected nodes are undetected, looping to reattempt node detection of undetected known nodes, and detecting unknown nodes within the network environment.

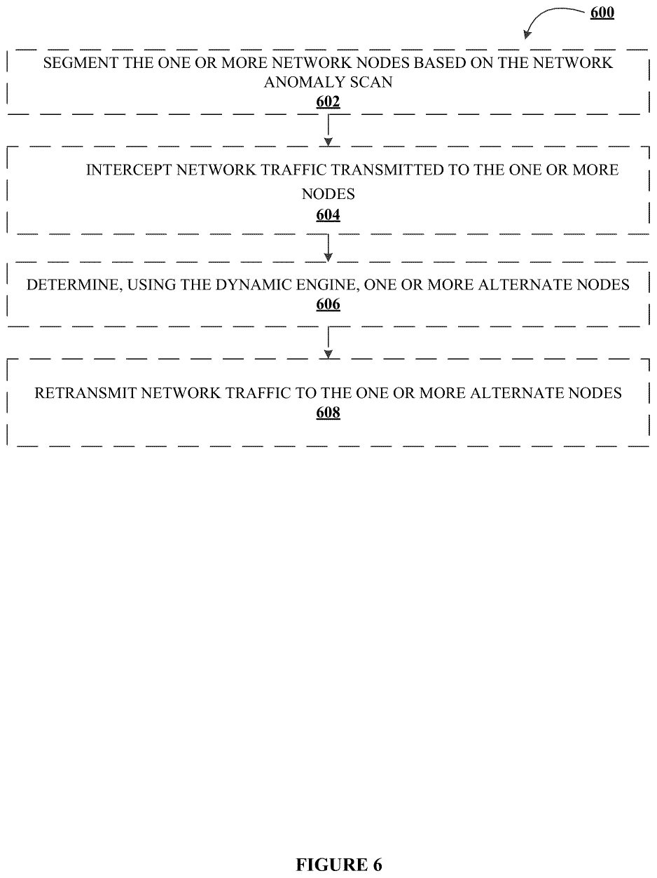

FIG. 6 illustrates a process flow 600 for determining one or more alternate nodes using the dynamic engine, in accordance with an embodiment of the disclosure. In some embodiments, a system (e.g., similar to one or more of the systems described herein with respect to FIGS. 1A-1C) may perform one or more of the steps of process flow 600. For example an anomaly detection and remediation in network environments using dynamic engine system (e.g., the system 130 described herein with respect to FIGS. 1A-1C) may perform the steps of process flow 600. In some embodiments, an AI engine (e.g., such as the AI engine like that described in FIG. 2) or a generative AI subsystem (e.g., such as the generative AI subsystem described in FIG. 3) may perform some or all of the steps described in process flow 600.

As shown in block 602, the process flow 600 may include the step of segmenting the one or more network nodes based on the network anomaly scan. In some embodiments, segmenting the one or more network nodes based on the network anomaly scan may comprise generating subnets to restrict network traffic flow from specific IP addresses, network nodes, network edges, network devices, and/or the like. According to some embodiments, the segmentation may comprise shutting down one or more network ports, shutting down the network in which the one or more network nodes operate, shutting down a network gateway, redirecting traffic through a specified port and/or gateway and/or subnet.

As shown in block 604, the process flow 600 may include the step of intercepting network traffic transmitted to the one or more nodes. According to some embodiments, the system, dynamic engine (which may comprise an AI engine and/or intelligent analytics engine), network gateway, network controller, and/or the like may intercept network traffic transmitted to the one or more nodes. In some embodiments, intercepting network traffic may comprise dynamically analyzing in real-time network data packets using a network monitoring application and/or determining whether to route the network traffic to a different network edge and/or network port. In some embodiments, intercepting network traffic may comprise utilizing a proxy server between nodes to intercept and/or modify traffic transmitted from a sending node to a receiving node along a network edge. According to some embodiments, intercepting network traffic may comprise security socket layer interception, transport layer security interception, and/or network taps. The system improves network security by intercepting network traffic that has been transmitted to nodes containing one or more anomalies, as transmitting network data packets to impacted nodes may result in security incidents, network latencies, network data corruption, performance issues, and/or the like.

As shown in block 606, the process flow 600 may include the step of determining, using the dynamic engine, one or more alternate nodes. According to some embodiments, the dynamic engine may determine the one or more alternate nodes to route the intercepted network traffic. The dynamic engine may determine a network gateway, router, switch, and/or network device for shifting network traffic from the one or more nodes to the one or more alternate nodes, according to some embodiments. The one or more alternate nodes may comprise global nodes, localized nodes, and/or the like, in some embodiments. The one or more alternate nodes may be associated with equivalent one or more distributed network data domains, data security requirements, network access controls, one or more thresholds, and/or the like as the one or more nodes to ensure continuity of network security, performance, and/or reliability, according to some embodiments.

As shown in block 608, the process flow 600 may include the step of retransmitting network traffic to the one or more alternate nodes. According to some embodiments, retransmitting network traffic may comprise selecting an available network gateway, router, switch, and/or network device (“retransmission device”) that meets retransmission criteria (e.g., one or more distributed network data domains, data security requirements, network access controls, one or more thresholds, and/or the like). The dynamic engine, system, and/or the like may make this selection, according to some embodiments. In some embodiments, retransmitting network traffic may comprise transmitting network traffic, via network data packets, that was previously intercepted to the one or more alternate nodes using the selected retransmission device. The one or more alternate nodes may transmit an acknowledgement transmission to retransmission device to confirm receipt of the rerouted network traffic, in some embodiments. According to some embodiments, the retransmission device may retransmit the network traffic one or more additional times if the acknowledgement transmission was not transmitted by the one or more alternate nodes and/or the initial acknowledgement transmission was not received by the retransmission device.

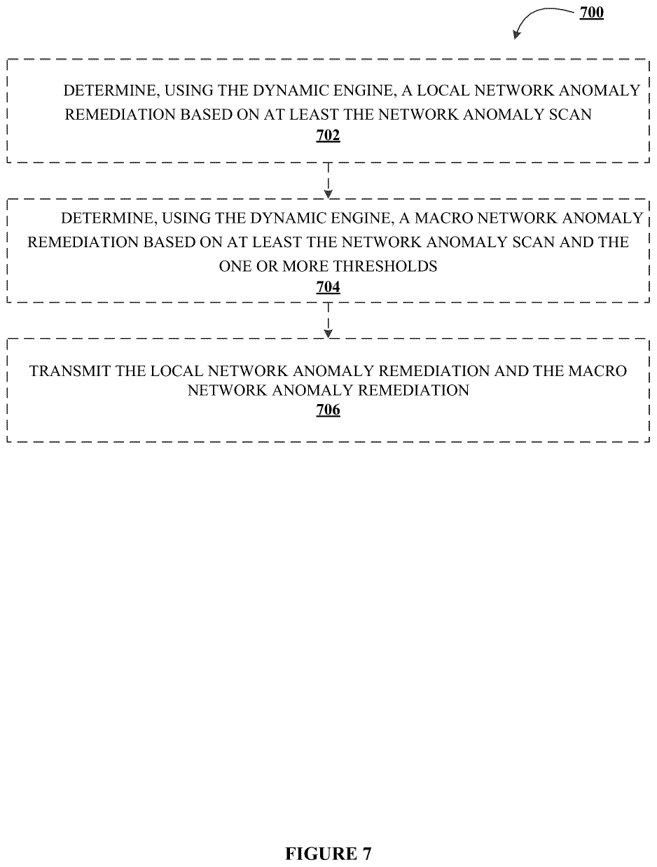

FIG. 7 illustrates a process flow 700 for determining and transmitting network anomaly remediations, in accordance with an embodiment of the disclosure. In some embodiments, a system (e.g., similar to one or more of the systems described herein with respect to FIGS. 1A-1C) may perform one or more of the steps of process flow 700. For example, an anomaly detection and remediation in network environments using dynamic engine system (e.g., the system 130 described herein with respect to FIGS. 1A-1C) may perform the steps of process flow 700. In some embodiments, an AI engine (e.g., such as the AI engine like that described in FIG. 2) or a generative AI subsystem (e.g., such as the generative AI subsystem described in FIG. 3) may perform some or all of the steps described in process flow 700.

As shown in block 702, the process flow 700 may include the step of determining, using the dynamic engine, a local network anomaly remediation based on at least the network anomaly scan. According to some embodiments, the dynamic engine may determine the local network anomaly remediation from the one or more localized network data metrics, network anomaly data scan, predetermined local anomaly remediation responsive actions, evolving network traffic, one or more thresholds, and/or the like.

In some embodiments, the local network anomaly remediation may comprise corrective responsive actions to mitigate a network anomaly detected in the localized nodes. Examples of corrective responsive actions may comprise determining at least one alternative localized node, shutting down a network edge associated with the network anomaly detected in the localized nodes, shutting down a network gateway associated with the impacted localized nodes, restricting intra-network and/or inter-network transmissions, partitioning at least one network into subnets for revising network traffic flow, shutting down network ports, opening additional network ports, requiring re-authenticating and re-authorizing access of a user and/or network device, revoking authorization, revoking access, implementing additional authorization and/or authentication requirements (e.g., multifactor authentication), increasing security requirements, updating software to implement security patches, executing maintenance on the impacted localized nodes, splitting nodes from a network node chain, splicing blocks from a distributed ledger, and/or the like. According to some embodiments, the dynamic engine may determine the local network anomaly remediation from a predetermined set of responsive actions, via a generative AI model, and/or via input from a user device associated with a user account.

As shown in block 704, the process flow 700 may include the step of determining, using the dynamic engine, a macro network anomaly remediation based on at least the network anomaly scan and the one or more thresholds. According to some embodiments, the dynamic engine may determine the macro network anomaly remediation from the global anomaly threshold, global network data unit metric, one or more thresholds, network anomaly data scan, predetermined macro anomaly remediation responsive actions, evolving network traffic, and/or the like.

In some embodiments, the macro network anomaly remediation may comprise corrective responsive actions to mitigate a network anomaly detected in the global nodes. Examples of corrective responsive actions may comprise determining at least one alternative global node, shutting down a plurality of network edges associated with the network anomaly detected in the global nodes, shutting down a network gateway associated with the impacted global nodes, restricting intra-network and/or inter-network transmissions, partitioning at least one network into subnets for revising network traffic flow, shutting down network ports, opening additional network ports, requiring re-authenticating and re-authorizing access of a user and/or network device, revoking authorization, revoking access, implementing additional authorization and/or authentication requirements (e.g., multifactor authentication), increasing security requirements, updating software to implement security patches, executing maintenance on the impacted global nodes, splitting a network node chain from the one or more distributed networks, splicing and/or removing a distributed ledger and/or data storage repository from the one or more distributed networks, and/or the like. According to some embodiments, the dynamic engine may determine the macro network anomaly remediation from a predetermined set of responsive actions, via a generative AI model, and/or via input from a user device associated with a user account.

As shown in block 706, the process flow 700 may include the step of transmitting the local network anomaly remediation and the macro network anomaly remediation. In some embodiments, the dynamic engine and/or system may generate and/or transmit the local network anomaly remediation and the macro network anomaly remediation via notification. In some embodiments, the notification may comprise transmitting network data packets, text message, email, instant message, audio transmissions, video transmissions, alert via user interface, and/or push notification to a mobile device. According to some embodiments, the notification may be transmitted via communication channel, may comprise end-to-end encryption, a secure socket layer, transport layer security, and/or the like.

By way of non-limiting example, and in some configurations, the local network anomaly remediation and the macro network anomaly remediation may be transmitted via the communication channel and displayed upon a user interface. The user interface may comprise a display comprising menus with the various options for the local network anomaly remediation and the macro network anomaly remediation. A user may select one of the various options utilizing input devices, a mixed reality application, buttons corresponding to the local network anomaly remediation and the macro network anomaly remediation, voice communications, and/or text messages, according to some embodiments. According to some embodiments, the local network anomaly remediation and the macro network anomaly remediation displayed on the user interface may comprise control buttons, wherein the control buttons (e.g., approve, reject, modify, and/or the like), upon selection, may comprise determined local network anomaly remediations and determined macro network anomaly remediations.

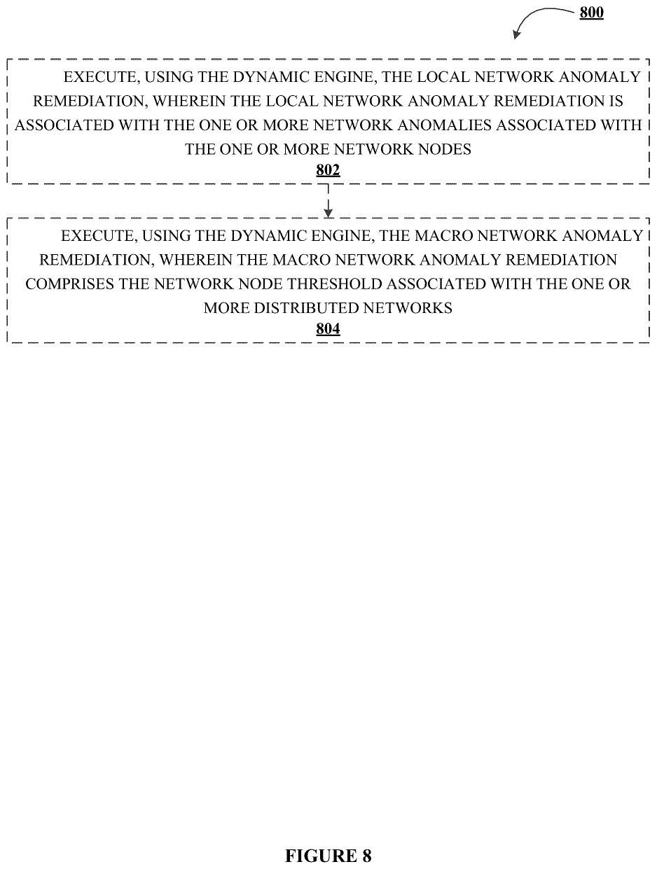

FIG. 8 illustrates a process flow 800 for executing network anomaly remediations, in accordance with an embodiment of the disclosure. In some embodiments, a system (e.g., similar to one or more of the systems described herein with respect to FIGS. 1A-1C) may perform one or more of the steps of process flow 800. For example, an anomaly detection and remediation in network environments using dynamic engine system (e.g., the system 130 described herein with respect to FIGS. 1A-1C) may perform the steps of process flow 800. In some embodiments, an AI engine (e.g., such as the AI engine like that described in FIG. 2) or a generative AI subsystem (e.g., such as the generative AI subsystem described in FIG. 3) may perform some or all of the steps described in process flow 800.

As shown in block 802, the process flow 800 may include the step of executing, using the dynamic engine, the local network anomaly remediation, wherein the local network anomaly remediation is associated with the one or more network anomalies associated with the one or more network nodes. In some embodiments, the local network anomaly remediation may comprise the determined local network anomaly remediations. According to some embodiments, executing the local network anomaly remediation comprises mitigating each known local network anomaly, known compromised localized node, and/or the like. The dynamic engine may execute the local network anomaly remediation dynamically upon detection of a network anomaly, continuously as network traffic evolves, via trigger from a device associated with a user, and/or at set intervals. In some embodiments, the dynamic engine may log the success or failure of the local network anomaly remediation in mitigating the network anomaly, determine additional local network anomaly remediations if the local network anomaly remediation fails and/or is disrupted, and/or the like.

As shown in block 804, the process flow 800 may include the step of executing, using the dynamic engine, the macro network anomaly remediation, wherein the macro network anomaly remediation comprises the network node threshold associated with the one or more distributed networks. In some embodiments, the macro network anomaly remediation may comprise the determined macro network anomaly remediations. According to some embodiments, executing the macro network anomaly remediation comprises mitigating each known global network anomaly, known compromised network chain, known compromised distributed ledger, and/or the like. The dynamic engine may execute the macro network anomaly remediation dynamically upon detection of a global network anomaly, continuously as network traffic evolves, via trigger from a device associated with a user, and/or at set intervals. In some embodiments, the dynamic engine may log the success or failure of the macro network anomaly remediation in mitigating the global network anomaly, determine additional macro network anomaly remediations if the macro network anomaly remediation fails and/or is disrupted, and/or the like.

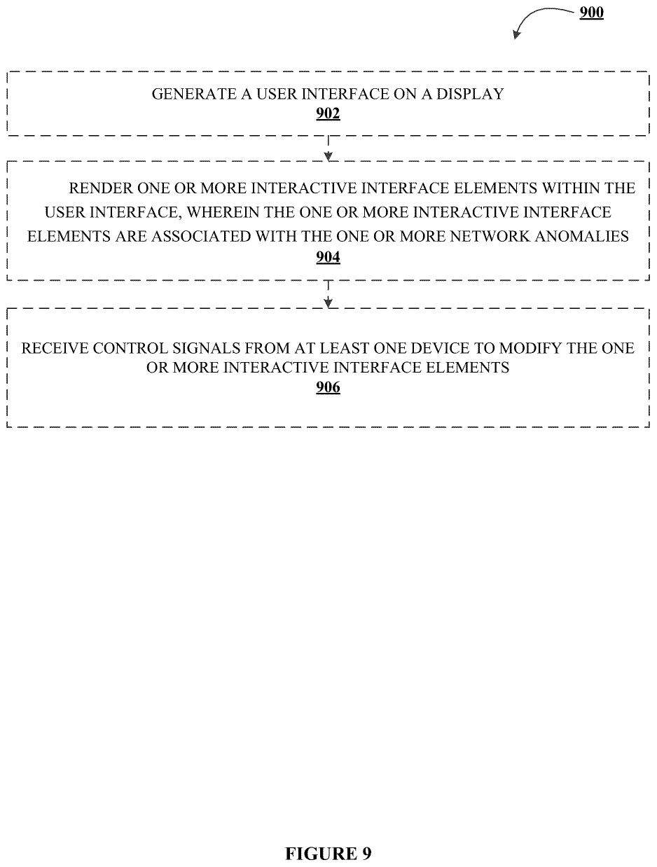

FIG. 9 illustrates a process flow 900 for rendering and modifying one or more interactive interface elements. In some embodiments, a system (e.g., similar to one or more of the systems described herein with respect to FIGS. 1A-1C) may perform one or more of the steps of process flow 900. For example, an anomaly detection and remediation in network environments using dynamic engine system (e.g., the system 130 described herein with respect to FIGS. 1A-1C) may perform the steps of process flow 900. In some embodiments, an AI engine (e.g., such as the AI engine like that described in FIG. 2) or a generative AI subsystem (e.g., such as the generative AI subsystem described in FIG. 3) may perform some or all of the steps described in process flow 900.

As shown in block 902, the process flow 900 may include the step of generating a user interface on a display. According to some embodiments, the user interface may be disposed within a display device, mixed reality headset, projector system, mobile device, glasses, and/or the like. The user interface may comprise input devices and output devices, including without limitation physical buttons, capacitive touch buttons, digital icons and buttons, audio transmitter, audio receiver, microphone, speaker, and/or headphones, according to some embodiments.

As shown in block 904, the process flow 900 may include the step of rendering one or more interactive interface elements within the user interface, wherein the one or more interactive interface elements are associated with the one or more network anomalies. According to some embodiments, the one or more interactive interface elements may comprise menus, channels associated with the determined network channel, icons, digital buttons, dashboards associated with the one or more network anomalies, digital objects, and/or the like. The one or more interactive elements may activate upon selection, interaction, and/or input from the user, according to some embodiments.

As shown in block 906, the process flow 900 may include the step of receiving control signals from at least one device to modify the one or more interactive interface elements. According to some embodiments, the control signals may be associated with input devices, mobile device, one or more network devices, the interactive interface elements, microphone, audio transmitter, and/or the like. By way of non-limiting example, and in some embodiments, a user may interact with the one or more interactive interface elements, which may generate control signals. According to some embodiments, the control signals may be associated with the determined local network anomaly remediations, determined macro network anomaly remediations, one or more thresholds, one or more nodes, one or more alternate nodes, one or more distributed network data domains, one or more distributed networks, distributed ledgers, distributed ledger blocks, local network anomaly remediation, macro network anomaly remediation, network data, one or more localized network data metrics, global network data unit metric, global anomaly threshold, network attribute set, one or more network attributes, one or more distributed network data domains, and/or the like.

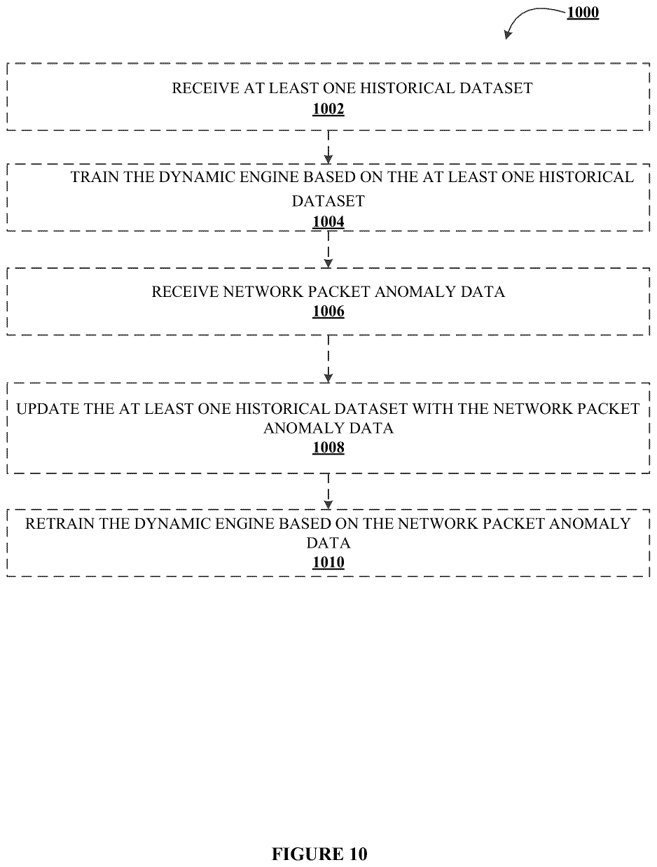

FIG. 10 illustrates a process flow 1000 for training and retraining the dynamic engine, in accordance with an embodiment of the disclosure. In some embodiments, a system (e.g., similar to one or more of the systems described herein with respect to FIGS. 1A-1C) may perform one or more of the steps of process flow 1000. For example, an anomaly detection and remediation in network environments using dynamic engine system (e.g., the system 130 described herein with respect to FIGS. 1A-1C) may perform the steps of process flow 1000. In some embodiments, an AI engine (e.g., such as the AI engine like that described in FIG. 2) or a generative AI subsystem (e.g., such as the generative AI subsystem described in FIG. 3) may perform some or all of the steps described in process flow 1000.

As shown in block 1002, the process flow 1000 may include the step of receiving at least one historical dataset. The at least one historical dataset may be stored in an internal data repository, hosted externally by an external network administrator, and/or the like. In some embodiments, the system may collect, compile, and/or aggregate historical data to create the at least one historical dataset and may store the at least one historical dataset in an internal data repository. In such a configuration, the system may access and retrieve the at least one historical dataset each time the dynamic engine may be trained, wherein the dynamic engine may comprise an AI engine, AI model, generative AI model, AI application, and/or the like. In some embodiments, the system may receive the at least one historical dataset continuously, at set internals, and/or via on-demand request generated by the dynamic engine, a user, a dynamic engine training controller, network device, and/or the like. In some embodiments, the system may receive the entire at least one historical dataset. According to sone embodiments, the system may only receive a subset of data contained within the at least one historical dataset based on training requirements associated with a dynamic engine training request generated by the system, user, network device, and/or the like. By training the dynamic engine on only a subset of the at least one historical dataset based on the most material and/or relevant data, the system may conserve computing resources, minimize energy expenditures, and/or enhance the dynamic engine performance. In some embodiments, the subset of data may not comprise sensitive data, preventing the inclusion of sensitive data in training the dynamic engine, which enhances data security and privacy.

As shown in block 1004, the process flow 1000 may include the step of training the dynamic engine based on the at least one historical dataset. In some embodiments, the at least one historical dataset comprises historical network data, historical determined local network anomaly remediations, historical determined macro network anomaly remediations, historical one or more thresholds, historical one or more nodes, historical one or more alternate nodes, historical one or more distributed network data domains, historical one or more distributed networks, historical distributed ledgers, historical distributed ledger blocks, historical local network anomaly remediation, historical macro network anomaly remediation, historical one or more localized network data metrics, historical global anomaly thresholds, historical one or more network attributes, historical network attribute sets, historical global network data unit metrics, historical control signals, and/or the like. In some embodiments the dynamic engine may comprise a generative AI model, in which training the generative AI model may comprise ingesting the historical dataset, adjusting parameters in response to generative AI model output, evaluating the model for fine-tuning, and/or deploying the generative AI model.

As shown in block 1006, the process flow 1000 may include the step of receiving network packet anomaly data. In some embodiments, receiving the network packet anomaly data may comprise receiving network data packets comprising network packet anomaly data. In some embodiments, a data aggregator may collect network packet anomaly data to generate aggregated network packet anomaly data and transmit the aggregated network packet anomaly data via network data packets to the system and/or dynamic engine. In some embodiments, the data aggregator may pre-process the network packet anomaly data, such as data cleansing, encrypting, and/or executing an ETL process. In some embodiments, the system may process the received network data packets, such as executing decryption, data extraction, and/or the like.

As shown in block 1008, the process flow 1000 may include the step of updating the at least one historical dataset with the network packet anomaly data. In some embodiments, the network packet anomaly data may be attached to the at least one historical dataset. In such a configuration, an ETL process may be executed to transmit the network packet anomaly data dataset to the same data storage repository as the at least one historical dataset.

As shown in block 1010, the process flow 1000 may include the step of retraining the dynamic engine based on the network packet anomaly data. The retraining step may be executed via feedback loop for continuous retraining and/or the retraining may occur via internal-based batch jobs, according to some embodiments. In some embodiments, the dynamic engine may refine itself by revising its weights and other such decision factors to improve accuracy, speed, and minimize errors, based on a dynamic engine training confidence threshold. In some embodiments, the system may determine the dynamic engine training confidence threshold, and if the dynamic engine training confidence threshold is below a given confidence threshold (e.g., predetermined, determined via notification from a network device, and/or dynamically determined by the system), the system may trigger retraining of the dynamic engine. In some embodiments, if criteria (e.g., one or more network anomalies, forecast network anomalies, one or more distributed network data domains, revised one or more distributed network data domains, network attribute set, revised network attribute set, and/or the like) and/or network packet anomaly data are generated and/or received by the system and/or dynamic engine (hereinafter referred to as “new training factors”), then the system and/or dynamic engine may trigger in real-time retraining of the dynamic engine based on the new training factors. By constantly monitoring for new training factors and triggering a responsive real-time retraining, the system provides a technical solution to the challenge of monitoring new training factors and changing network traffic conditions and adjusting the system dynamically.

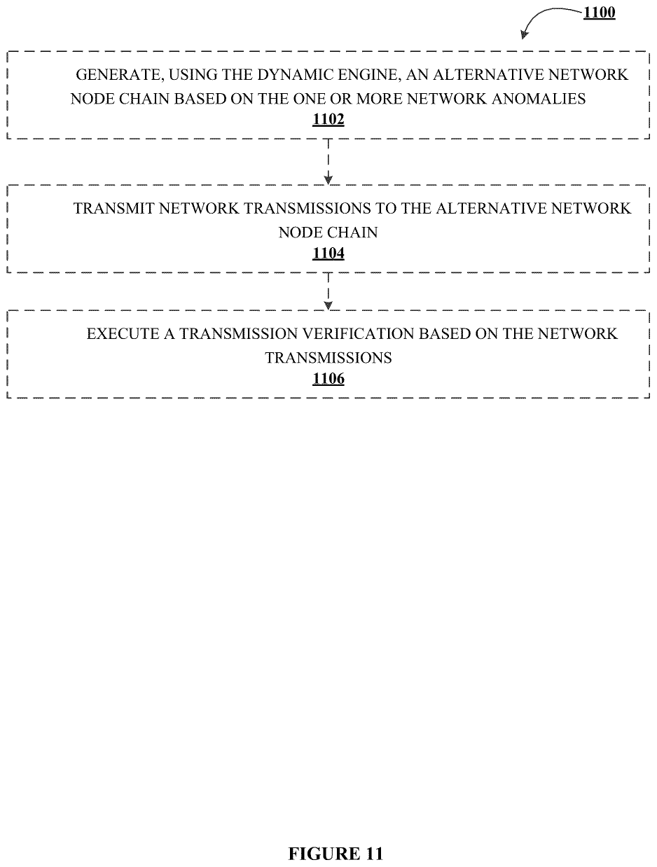

FIG. 11 illustrates a process flow 1100 generating an alternative network node chain, in accordance with an embodiment of the disclosure. In some embodiments, a system (e.g., similar to one or more of the systems described herein with respect to FIGS. 1A-1C) may perform one or more of the steps of process flow 1100. For example, an anomaly detection and remediation in network environments using dynamic engine system (e.g., the system 130 described herein with respect to FIGS. 1A-1C) may perform the steps of process flow 1100. In some embodiments, an AI engine (e.g., such as the AI engine like that described in FIG. 2) or a generative AI subsystem (e.g., such as the generative AI subsystem described in FIG. 3) may perform some or all of the steps described in process flow 1100.

As shown in block 1102, the process flow 1100 may include the step of generating, using the dynamic engine, an alternative network node chain based on the one or more network anomalies. In some embodiments, generating an alternate network node chain may comprise determining to segment at least a portion of a known network node chain based on the one or more network anomalies. Generating an alternate network node chain may comprise exporting data, metadata, smart contracts, reference addresses, transaction histories, and/or the like from the at least a portion of a known network node chain to an intermediate data storage repository, according to some embodiments. In addition, the dynamic engine may determine a validation protocol for the alternative network node chain, according to some embodiments. The validation protocol may comprise one or more validator nodes; validating requirements, specifications, connectivity, IP addresses, and/or configurations of each node in the alternative network node chain; and/or a consensus algorithm (e.g., proof-of-work, proof-of-stake, practical byzantine fault tolerance, and/or the like). The dynamic engine may deploy the nodes of the alternate network node chain and/or initialize the alternate network node chain, according to some embodiments.

As shown in block 1104, the process flow 1100 may include the step of transmitting network transmissions to the alternative network node chain. In some embodiments, the system, dynamic engine, and/or the like may transmit the network transmissions. According to some embodiments, transmitting network transmissions to the alternative node chain may comprise executing test transactions to the alternative node chain, validating transactions, appending validated transactions to a node block, and/or the like. According to some embodiments, the network transmissions may be transmitted via network data packets, ETL process, and/or the like.

As shown in block 1106, the process flow 1100 may include the step of executing a transmission verification based on the network transmissions. In some embodiments, executing a transmission verification based on the network transmissions may comprise the alternative node chain transmitting a verification message to confirm receipt of the network transmissions. According to some embodiments, the network transmissions may be retransmitted one or more additional times if the verification message was not transmitted by the alternative node chain and/or the verification message was not received.

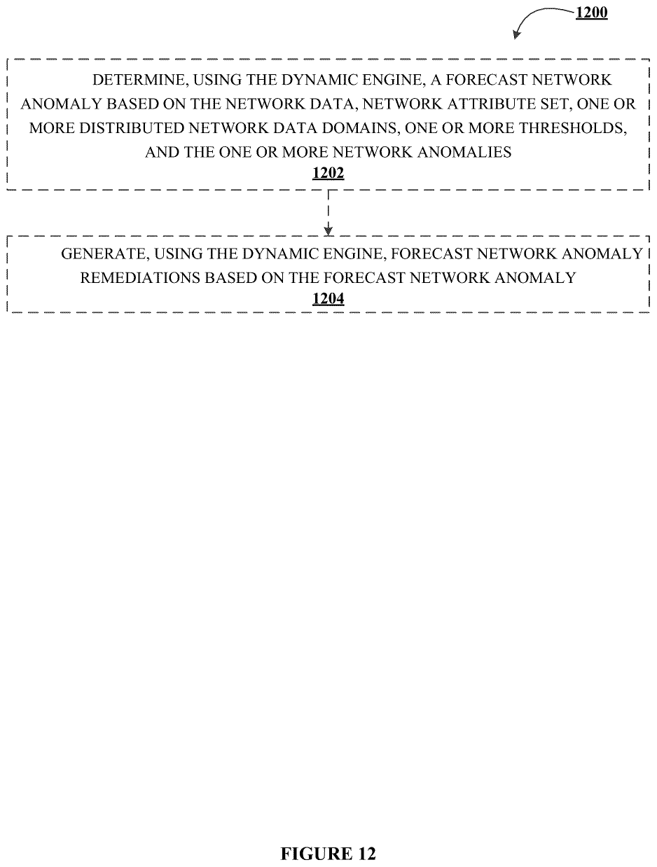

FIG. 12 illustrates a process flow 1200 for forecasting network anomalies and generating remediations, in accordance with an embodiment of the disclosure. In some embodiments, a system (e.g., similar to one or more of the systems described herein with respect to FIGS. 1A-1C) may perform one or more of the steps of process flow 1200. For example, an anomaly detection and remediation in network environments using dynamic engine system (e.g., the system 130 described herein with respect to FIGS. 1A-1C) may perform the steps of process flow 1200. In some embodiments, an AI engine (e.g., such as the AI engine like that described in FIG. 2) or a generative AI subsystem (e.g., such as the generative AI subsystem described in FIG. 3) may perform some or all of the steps described in process flow 12000.

As shown in block 1202, the process flow 1200 may include the step of determining, using the dynamic engine, a forecast network anomaly based on the network data, network attribute set, one or more distributed network data domains, one or more thresholds, and the one or more network anomalies. According to some embodiments, the dynamic engine may generate forecast network anomalies using a forecasting model, AI engine, and/or a generative AI model. The dynamic engine may compare the network data, network attribute set, one or more distributed network data domains, one or more thresholds, and/or the one or more network anomalies to network data packets from continuous network traffic to determine forecast network anomalies, in some embodiments. The forecast network anomalies may comprise emerging abnormal conditions based on emerging threats external to the one or more distributed networks. The dynamic engine may receive network analytics data from a plurality of sources and may analyze trends, abnormal patterns, suspicious activities, and/or the like in the network analytics data using an intelligent analytics engine, according to some embodiments. In such a configuration, and in some embodiments, the dynamic engine determines the forecast network anomalies based on the outputs of the intelligent analytics engine.

As shown in block 1204, the process flow 1200 may include the step of generating, using the dynamic engine, forecast network anomaly remediations based on the forecast network anomaly. The dynamic engine may generate the forecast network anomaly remediations to safeguard the one or more distributed networks from forecast network anomalies. The forecast network anomaly remediations may comprise corrective actions to prevent network anomalies from penetrating and propagating throughout the one or more distributed networks, in some embodiments. Examples of corrective responsive actions may comprise shutting down a network edge associated with the network anomaly detected in the localized nodes, shutting down a network gateway, restricting intra-network and/or inter-network transmissions, partitioning at least one network into subnets for revising network traffic flow, shutting down network ports, opening additional network ports, requiring re-authenticating and re-authorizing access of a user and/or network device, revoking authorization, revoking access, implementing additional authorization and/or authentication requirements (e.g., multifactor authentication), increasing security requirements, updating software to implement security patches, executing maintenance on the impacted nodes, splitting nodes from a network node chain, splicing blocks from a distributed ledger, and/or the like, according to some embodiments.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for anomaly detection and remediation in network environments using a dynamic engine, the system comprising:
a memory device with computer-readable program code stored thereon;
at least one processing device, wherein executing the computer-readable program code is configured to cause the at least one processing device to execute the computer-readable program code to:
receive and extract network data from one or more distributed networks;
identify one or more distributed network data domains based on the network data;
generate a network attribute set based on at least the one or more distributed network data domains, wherein the network attribute set comprises network attributes;
determine, using a dynamic engine, one or more thresholds associated with the one or more network attributes;
identify, using the dynamic engine, one or more network anomalies based on at least the one or more thresholds associated with the one or more network attributes; and
transmit an anomaly alert notification, wherein the anomaly alert comprises the one or more network anomalies.

2. The system of claim 1, wherein the one or more thresholds further comprises:
at least one of a downstream chain threshold, lateral dispersion threshold, recursive frequency threshold, network data aggregation threshold, and convolution threshold.

3. The system of claim 1, wherein executing the computer-readable program code is further configured to cause the at least one processing device to:
determine, using the dynamic engine, a network node threshold associated with the one or more distributed networks;
determine, using the dynamic engine, one or more network nodes associated with the one or more thresholds; and
execute, using the dynamic engine, a network anomaly scan based on at least the network node threshold and the one or more network nodes associated with the one or more thresholds.

4. The system of claim 3, wherein executing the computer-readable program code is further configured to cause the at least one processing device to:
segment the one or more network nodes based on the network anomaly scan;
intercept network traffic transmitted to the one or more nodes;
determine, using the dynamic engine, one or more alternate nodes; and
retransmit network traffic to the one or more alternate nodes.

5. The system of claim 3, wherein executing the computer-readable program code is further configured to cause the at least one processing device to:
determine, using the dynamic engine, a local network anomaly remediation based on at least the network anomaly scan;
determine, using the dynamic engine, a macro network anomaly remediation based on at least the network anomaly scan and the one or more thresholds; and
transmit the local network anomaly remediation and the macro network anomaly remediation.

6. The system of claim 5, wherein executing the computer-readable program code is further configured to cause the at least one processing device to:
execute, using the dynamic engine, the local network anomaly remediation, wherein the local network anomaly remediation is associated with the one or more network anomalies associated with the one or more network nodes; and
execute, using the dynamic engine, the macro network anomaly remediation, wherein the macro network anomaly remediation comprises the network node threshold associated with the one or more distributed networks.

7. The system of claim 1, wherein executing the computer-readable program code is further configured to cause the at least one processing device to:
generate a user interface on a display;
render one or more interactive interface elements within the user interface, wherein the one or more interactive interface elements are associated with the one or more network anomalies; and
receive control signals from at least one device to modify the one or more interactive interface elements.

8. The system of claim 1, wherein executing the computer-readable program code is further configured to cause the at least one processing device to:
receive at least one historical dataset;
train the dynamic engine based on the at least one historical dataset;
receive network packet anomaly data;
update the at least one historical dataset with the network packet anomaly data; and
retrain the dynamic engine based on the network packet anomaly data.

9. The system of claim 1, wherein executing the computer-readable program code is further configured to cause the at least one processing device to:
generate, using the dynamic engine, an alternative network node chain based on the one or more network anomalies;
transmit network transmissions to the alternative network node chain; and
execute a transmission verification based on the network transmissions.

10. The system of claim 1, wherein executing the computer-readable program code is further configured to cause the at least one processing device to:
determine, using the dynamic engine, a forecast network anomaly based on the network data, network attribute set, one or more distributed network data domains, one or more thresholds, and the one or more network anomalies; and
generate, using the dynamic engine, forecast network anomaly remediations based on the forecast network anomaly.

11. A computer program product for anomaly detection and remediation in network environments using a dynamic engine, wherein the computer program product comprises at least one non-transitory computer-readable medium having computer-readable program code portion embodied therein, the computer-readable program code portions which when executed by a processing device are configured to cause a processor to:
receive and extract network data from one or more distributed networks;
identify one or more distributed network data domains based on the network data;
generate a network attribute set based on at least the one or more distributed network data domains, wherein the network attribute set comprises network attributes;
determine, using a dynamic engine, one or more thresholds associated with the one or more network attributes;
identify, using the dynamic engine, one or more network anomalies based on at least the one or more thresholds associated with the one or more network attributes; and
transmit an anomaly alert notification, wherein the anomaly alert comprises the one or more network anomalies.

12. The computer program product of claim 11, wherein the one or more thresholds further comprises:
at least one of a downstream chain threshold, lateral dispersion threshold, recursive frequency threshold, network data aggregation threshold, and convolution threshold.

13. The computer program product of claim 11, wherein the processing device is further configured to:
determine, using the dynamic engine, a network node threshold associated with the one or more distributed networks;
determine, using the dynamic engine, one or more network nodes associated with the one or more thresholds; and
execute, using the dynamic engine, a network anomaly scan based on at least the network node threshold and the one or more network nodes associated with the one or more thresholds.

14. The computer program product of claim 13, wherein the processing device is further configured to:
segment the one or more network nodes based on the network anomaly scan;
intercept network traffic transmitted to the one or more nodes;
determine, using the dynamic engine, one or more alternate nodes; and
retransmit network traffic to the one or more alternate nodes.

15. The computer program product of claim 13, wherein the processing device is further configured to:
determine, using the dynamic engine, a local network anomaly remediation based on at least the network anomaly scan;
determine, using the dynamic engine, a macro network anomaly remediation based on at least the network anomaly scan and the one or more thresholds; and
transmit the local network anomaly remediation and the macro network anomaly remediation.

16. The computer program product of claim 15, wherein the processing device is further configured to:
execute, using the dynamic engine, the local network anomaly remediation, wherein the local network anomaly remediation is associated with the one or more network anomalies associated with the one or more network nodes; and
execute, using the dynamic engine, the macro network anomaly remediation, wherein the macro network anomaly remediation comprises the network node threshold associated with the one or more distributed networks.

17. The computer program product of claim 11, wherein the processing device is further configured to:
generate, using the dynamic engine, an alternative network node chain based on the one or more network anomalies;
transmit network transmissions to the alternative network node chain; and
execute a transmission verification based on the network transmissions.

18. The computer program product of claim 11, wherein the processing device is further configured to:
determine, using the dynamic engine, a forecast network anomaly based on the network data, network attribute set, one or more distributed network data domains, one or more thresholds, and the one or more network anomalies; and
generate, using the dynamic engine, forecast network anomaly remediations based on the forecast network anomaly.

19. A computer-implemented method for anomaly detection and remediation in network environments using a dynamic engine:
receiving and extracting network data from one or more distributed networks;
identifying one or more distributed network data domains based on the network data;
generating a network attribute set based on at least the one or more distributed network data domains, wherein the network attribute set comprises network attributes;
determining, using a dynamic engine, one or more thresholds associated with the one or more network attributes;
identifying, using the dynamic engine, one or more network anomalies based on at least the one or more thresholds associated with the one or more network attributes; and
transmitting an anomaly alert notification, wherein the anomaly alert comprises the one or more network anomalies.

20. The computer-implemented method of claim 19, wherein the computer-implemented method is further configured for:
determining, using the dynamic engine, a network node threshold associated with the one or more distributed networks;
determining, using the dynamic engine, one or more network nodes associated with the one or more thresholds; and
executing, using the dynamic engine, a network anomaly scan based on at least the network node threshold and the one or more network nodes associated with the one or more thresholds.
